(19) United States
(12) Patent Application Publication
(10) Pub. No.: US 2003/0084183 A1
(43) Pub. Date: May 1, 2003

(54) Dynamic transferring software/protocol

(76) Inventors: Anders Odlund, Enebyberg (SE); Kenth Andersson, Borlange (SE); Kent Karlsson, Jarfalla (SE); Emil Petersson, Jarfalla (SE)

Correspondence Address: JENKENS & GILCHRIST, 3200 Fountain Place, 1445 Ross Avenue, Dallas, TX, 75202-2799, US

(21) Appl. No.: 10/261,980

(22) Filed: Sep. 30, 2002

Related U.S. Application Data
(60) Provisional application No. 60/325,858, filed on Sep. 28, 2001.

(51) Int. Cl. G06F 15/16

(52) U.S. Cl. 709/234; 709/219

(57) ABSTRACT

A dynamic transferring software/protocol (UFT) by which “live” data, such as audio/visual data, can be transferred through a communications network. With UFT, data is transferred from a first point in the communications network to a second point in the communications network at the fastest transfer rate the network will allow, and is transferred from the second point to the client at a fixed transfer rate requested by the client. The data can be served to the client from the second point without waiting for the data to be fully transferred to the second point. Also, if a transfer to the client is aborted, it may be restarted from where it left off.

This application claims the benefit of copending Provisional Patent Application Serial No. 60/325,858, filed on Sep. 28, 2001.

### BACKGROUND OF THE INVENTION

1. Field of the Invention

The present invention relates generally to a method and apparatus for transferring data; and, more particularly, to a method and apparatus for transferring “live” data, such as an audio or visual data stream, over a communications network.

2. Description of the Prior Art

File Transfer Protocol (FTP) is a common way to upload and download files over the Internet. Typically, a site on the Internet stores a number of files and runs an FTP originating server application that waits for a transfer request. In order to download a file, an FTP client application is run that connects to the FTP originating server, and requests a file from a particular directory or folder. One advantage of FTP is that the size of a file being transferred is limited only by amount of space allocated on the server.

File Transfer Protocol, however, is not fully satisfactory in many applications. For example, when transferring live data, such as an audio or visual data stream, through a network from an originating server to a client using FTP, the data is typically streamed through the entire network at a fixed rate as requested by the client; and it can require a substantial period of time for the data to be fully transferred to the client. As an example, if a client requests a 200 Kbits/sec stream having a file size of 20 MB, it will require approximately 13 minutes of transfer time to transfer the data using FTP. Such a situation obviously does not provide a satisfactory user experience; and, in addition, limits the ability of the network to handle additional transfers.

In networks that use a cache/relay system to avoid bottlenecks, the time required to transfer a file to a client can be reduced by uploading the file in advance. Doing so, however, requires that the provider of the file, e.g., a creator, distributor or operator, be able to predict what file a client might wish to receive, and most providers would prefer that the transfer of a file to a client be done dynamically, i.e., that a file be transferred from the originating server to the client only when the client requests it. In any event, even if files are uploaded in advance, if the client requests a file that has not been uploaded, the requested file will still have to be streamed through the entire network from the originating server at the requested rate.

Another problem that is encountered when transferring files dynamically using FTP, is that the client must wait until an entire file has been transferred before it can be executed. For this reason, when a data stream that is in the process of being transferred from an originating server to a client is aborted by the client, only the part that has been streamed all the way to the client will be cached. Accordingly, if the data transfer is later resumed, the transfer must be restarted from the beginning in order for the client to receive the entire file. This is wasteful of time and annoying to the client.

### SUMMARY OF THE INVENTION

The present invention provides a method and apparatus for transferring data over a communications network. In particular, the present invention provides a dynamic transferring software/protocol by which “live” data, such as audio/visual data, can be efficiently transferred through a communications network in a manner that avoids the above-described inadequacies of FTP. The dynamic transferring software/protocol according to the present invention is generally referred to herein as “Universal File Protocol” or “UFT”.

UFT is a file transfer tool that uses both IP (Internet Protocol) and TCP (Transmission Control Protocol), but that has its own Control Protocol. As will be described more fully hereinafter, UFT, in effect, functions to create a “tunnel” between two points in the communications network, e.g., between an originating server and a cache/server, through which the data can be pushed/pulled as fast as possible without regard to the data rate requested by the client. According to an exemplary embodiment of the present invention, for example, UFT permits a file/stream to be sent over a communications network from an originating server to an “end” server as fast as the network will allow by using all available bandwidth, with the result being that files can be transferred through the network much more quickly or with less interference of a higher prioritized transfer than with FTP. In effect, UFT doesn't care if one or many files are being transferred or if the files being transferred are at a fixed rate stream. The data is simply transferred from the originating server to the end-server as fast as possible, and is then transferred from the end server to the client at the fixed rate requested by the client.

According to a further exemplary embodiment of the invention, UFT permits a file being transferred to be served/executed without having to wait for the file to be fully transferred. With UFT, a file can be served as soon as the first bits hit the end server, thus providing a highly favorable user experience.

In yet a further exemplary embodiment of the present invention, if a data stream transfer is aborted by a user before the transfer has been completed, the transfer may be restarted from where it left off without having to start the stream from the beginning.

The performance advantages of UFT as compared to FTP are especially significant when transferring at least several files. Even when only one file is being transferred, however, several advantages are provided, including dynamic allocation, the ability to resume an interrupted data transfer where it left off and the ability to start serving the client as soon as the first bits arrive at the end server. In general, UFT provides a very versatile technique for transferring data, such as audio/visual data, over a network; and can be effectively utilized in numerous applications.

### BRIEF DESCRIPTION OF THE DRAWINGS

The foregoing and other advantages of the invention will become apparent upon reading the following detailed description, when taken in conjunction with the following drawings, wherein:

FIG. 1 is a block diagram that schematically illustrates a communications network through which data may be transferred to assist in explaining the present invention;

FIG. 2 is a diagram that illustrates a comparison between FTP and UFT according to exemplary embodiments of the present invention to assist in explaining advantageous features of the present invention; and

FIG. 3 is a flow chart that schematically illustrates steps of a method for transferring files through a communications network according to another exemplary embodiment of the present invention.

### DETAILED DESCRIPTION OF EXEMPLARY EMBODIMENTS OF THE INVENTION

FIG. 1 is a block diagram that schematically illustrates a communications network through which data may be transferred to assist in explaining the present invention. The network is generally designated by reference number 10 and functions to transfer data from a data provider 12, such as a creator, distributor or operator, to a client 14 that is desirous of receiving the data.

Provider 12 is connected to the communications network 10 through an originating server 16 of the network, and the client 14 is connected to the network 10 through a cache/server 18 of the network. When client 14 desires to receive a particular file, a client application is run that connects to the originating server 16; and the desired file is transferred to the client via the network 10 over the Internet as is schematically indicated by reference number 20

Commonly, File Transfer Protocol (FTP) is used to transmit files through an Internet network such as network 10. When using FTP to transfer live data, such as audio or visual data, the data is typically streamed through the network at a fixed rate as requested by the client from an FTP originating server 16 through an FTP cache/server 18 to the client 14. A common rate for transmitting live data is 200 Kbits/sec, and at such a rate, a substantial amount of time is required to transfer a data file to a client, particularly when the file is relatively large. In addition, when using FTP, it is necessary for the data to be fully transferred from the originating server 16 to the cache/server 18 before it can be executed by the client. If the client aborts a file transfer before it has been completed, only the part of the file that has been streamed to the cache/server will be cached. As a result, when the transfer is resumed, it must be restarted from the beginning in order for the client to receive the entire stream from the FTP originating server 16.

Recognizing the deficiencies of FPT when transferring live data, the present invention has been developed to provide a dynamic transferring software/protocol by which live data, such as audio or visual data, can be more efficiently transferred through a communications network. The Dynamic Transferring software/protocol according to the present invention is generally referred to herein as “UFT” (Universal File Transfer) protocol. As will be explained more fully hereinafter, UFT permits live data to be transmitted through the network much more quickly or with less interference of a higher prioritized transfer than with FTP; and, in addition, permits transferred data to be served/executed as soon as the first bits hit the cache/server, unlike FTP that requires that an entire file be transferred before it can be executed. In addition, if a data transfer is aborted before it has been fully transferred to the cache/server, the transfer can be resumed from the point where it left off rather than having to start the transfer from the originating server all over again from the beginning as when using FTP.

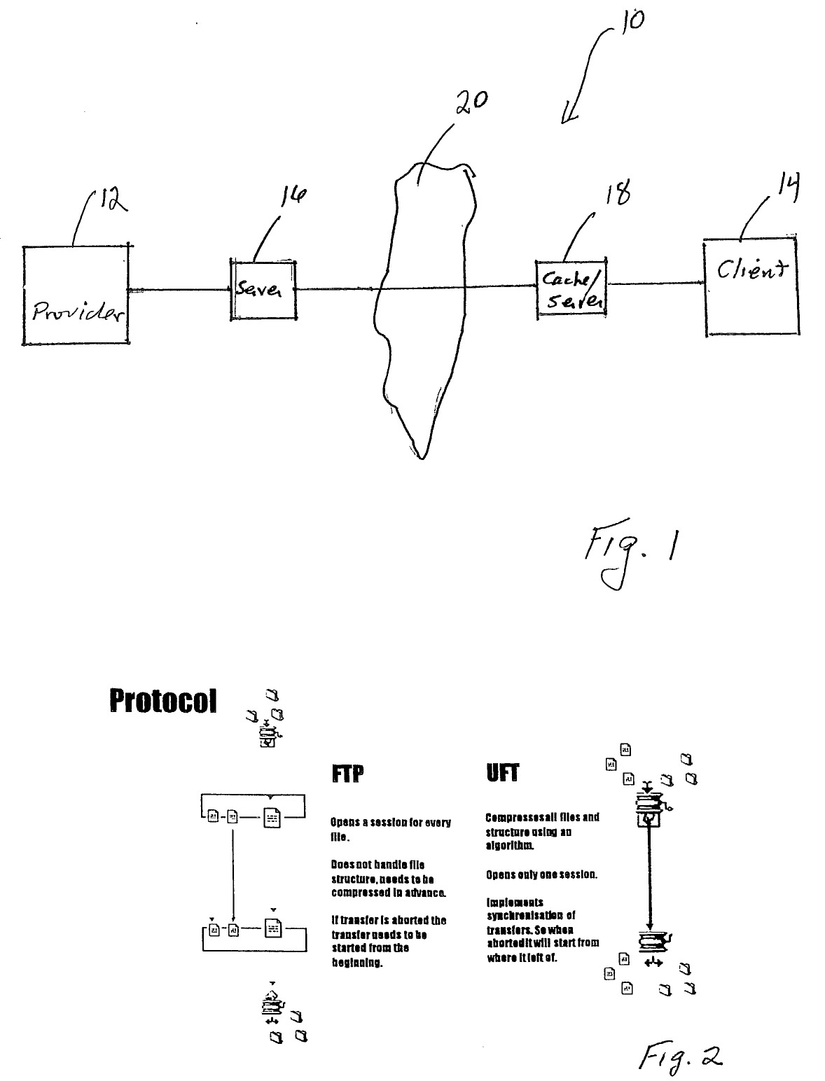

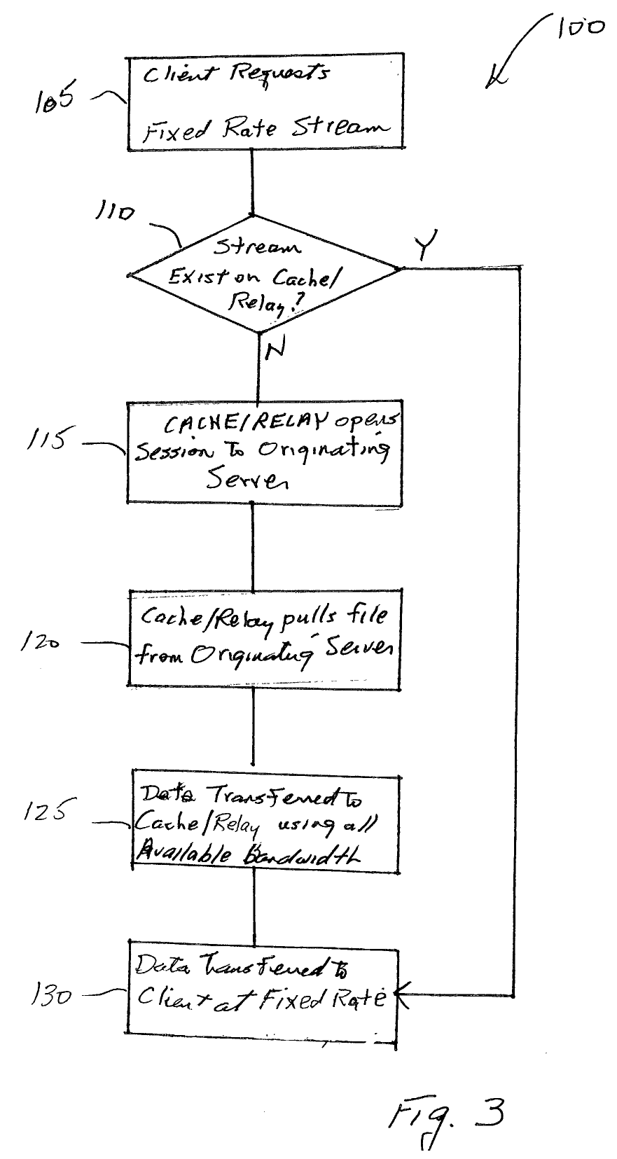

According to an exemplary embodiment of the invention, UFT uses IP (Internet Protocol) for transport and TCP (Transmission Control Protocol) for error handling and its own Control Protocol for controlling the transfer. In effect, the UFT Control Protocol creates a “tunnel” between first and second points in a communications network through which a data stream can be transmitted at an increased rate irrespective of the bit rate requested by the client. In accordance with an exemplary embodiment of the invention, the Control Protocol uses all “spare” bandwidth in the network to make the transfer, so that the transfer from the first point to the second point can be made as fast as possible. FIG. 2 is a diagram that illustrates differences between FTP and UFT according to exemplary embodiments of the present invention in order to provide a clearer understanding of advantageous features provided by the present invention

With reference to FIG. 1, UFT can conveniently be used to transfer files from originating server 16 (point 1) to cache/server 18 (point 2) at a first, fast transfer rate. The files are then transferred from cache/server 18 to the client 14 at a second, fixed transfer rate requested by the client.

According to an exemplary embodiment of the present invention, the data stream is able to be transferred from originating server 16 to cache/server 18 by providing a UFT originating server 16. UFT originating server 16 acts like a client parsing the file stream to be transferred and then creates an RTP-file (Real-Time Protocol-file) of it, i.e., it is “frozen” as a stream. The data stream is then handled like a file and UFT transfers the file as fast as the network will allow to the cache/server 18 where it is saved as an RTP-file. By saving the data as an RTP-file on the cache/server, the cache/server doesn't need to parse the file, thus saving processor power. In addition, the file is smaller, thus also saving space. Furthermore, because the cache/server doesn't have to wait until the file being transferred is transferred in full, and because it doesn't have to parse the file, the cache/server can start serving the stream to the client as soon as the first bits hit the cache/server.

By transferring data using UFT, a significant savings in transfer time can be realized. For example, a 200 Kbit/sec stream with a file size of 20 MB, using all available bandwidth in the network can be transferred in about 16 seconds using UFT, whereas about 13 minutes of live streaming is required using FTP. To transfer large amounts of data, for example, a file structure of 240,000 files, 1.6 GB on a 100 MB network requires about 11 minutes using UFT and about six hours using FTP. In general, the more files that are being transferred, the greater the speed advantage gained by using UFT. In this regard, as shown in FIG. 2, with FTP, a session must be opened for every file to be transferred. In comparison, with UFT, only one session is opened. It doesn't matter how many files are to be transferred.

As indicated above, an important feature of UFT is that if a data transfer is interrupted, the data transfer can be restarted at the point of the interruption without it being necessary to transfer the data from the beginning from the originating server. According to an exemplary embodiment of the present invention, this is accomplished by providing a UFT cache/server 18 on the client side. The UFT cache/server receives the data being transferred from the originating UFT server 16 and saves it in a buffer. As soon as a connection is reestablished, the the UFT server will start transferring data to the client from the buffer at the point where the interruption occurred. It should be noted that for the client, this is taking place in the background, and actually simulates a fixed connection because of the very high speed at which data is transferred with the present invention.

In the present invention, the bandwidth of the network is used as efficiently as possible, this permits live data, such as speech and billing, to be prioritized based on available capacity. Such “dynamic allocation” is another important capability of the present invention.

FIG. 3 is a flow chart that schematically illustrates steps of a typical data transfer session 100 utilizing UFT according to an exemplary embodiment of the present invention. In step 105, a client requests a fixed rate stream, for example, a 200 Kbit stream with a file size of 20 MB. If it is determined that the stream does not exist on the cache/relay (No output of step 110), the cache/relay opens a UFT session to the originating server (step 115). The cache/relay then “pulls” the file from the originating server (step 120), and the originating server will transfer the file to the cache/server using all available bandwidth (step 125). As soon as the first bits hit the cache/server, the data will be served to the client at the requested fixed rate (step 130). If the stream does exist on the cache/relay (Yes output of step 110), the data is transferred directly from the cache/relay to the client as is illustrated in FIG. 3.

According to one exemplary embodiment of the present invention, UFT is implemented in Unix, although it can also be implemented in other ways, and it is not intended to limit the implementation in any way. The communications network can be any network utilizing the Internet such as, for example, a wireless telecommunications network.

While what has been described herein constitute exemplary embodiments of the invention, it should be recognized that the invention can be varied in many ways without departing therefrom. For example, although in the above description, the first and second points of the network were identified as being the originating server and the cache/server, the points could also be located at other nodes in the network. Because the present invention can be varied in many ways, it should be understood that the invention should be limited only insofar as is required by the scope of the following claims.

1. A method for transferring data from a data provider to a client through a communications network, comprising:
transferring the data from a first point in the communications network to a second point in the communications network at a first transfer rate; and
transferring the data from the second point to the client at a second data transfer rate.

2. The method according to claim 1, wherein said first transfer rate is greater than said second transfer rate.

3. The method according to claim 2, wherein said second transfer rate is a fixed transfer rate requested by the client.

4. The method according to claim 1, wherein said data is transferred from said first point to said second point using substantially all available bandwidth of said communications network.

5. The method according to claim 4, wherein said step of transferring the data from said first point to said second point comprises parsing a data stream to be transferred, and creating an RTP-file of the parsed data stream.

6. The method according to claim 1, wherein said step of transferring the data from the second point to the client comprises starting to serve the data to the client as soon as the data begins to reach the second point.

7. The method according to claim 1, and further including the step of resuming an interrupted transfer of data from the second point to the client at a point in the data stream where the interruption occurred.

8. The method according to claim 1, wherein said first point comprises an originating server, and wherein said second point comprises a cache/server.

9. A method for transferring a data stream from a data provider to a client through a communications network, comprising:
said client requesting a data stream at a fixed transfer rate;
determining if said requested stream exists at a second point in said network;
if not, transferring said stream from a first point in said network to said second point in said network at a first transfer rate; and
transferring said stream from said second point to said client at said fixed transfer rate.

10. The method according to claim 9, wherein said first transfer rate is greater than said fixed transfer rate.

11. The method according to claim 9, wherein said data stream is transferred from said first point to said second point using substantially all available bandwidth.

12. The method according to claim 9, wherein said first point comprises an originating server, and said second point comprises a cache/server.

13. An apparatus for transferring a data stream from a data provider to a client through a communications network, comprising:
an originating server and a cache/server, said originating server transferring said data stream to said cache/server at a first, relatively fast data rate; and
said cache/server transferring said data stream to said client at a second, relatively slower data rate requested by said client.

14. The apparatus according to claim 13, wherein said originating server transfers said data stream to said cache/server using substantially all available bandwidth of said communications network.
